(19) United States
(12) Patent Application Publication
(10) Pub. No.: US 2019/0001468 A1
(43) Pub. Date: Jan. 3, 2019

(54) Device for Clamping a Part to a Tool

(71) Applicant: Christophe Boiteux, Landresse (FR)

(72) Inventor: Christophe Boiteux, Landresse (FR)

(21) Appl. No.: 15/748,912

(22) PCT Filed: Jul. 29, 2016
(86) PCT No.: PCT/FR2016/051985

§ 371 Date: Jan. 30, 2018

(30) Foreign Application Priority Data
Jul. 31, 2015 (FR) 1557358

(51) Int. Cl. B25B 5/06

(52) U.S. Cl. CPC B25B 5/062

(57) ABSTRACT

A device for clamping a part to a tool includes an arm and a body that is fastened when in use to the tool, the arm being mounted in a movable manner on the body and being driven by actuating means between a clamping position and a releasing position, and undergoing a pure movement in translation along an arm axis at the end of its travel towards its clamping position and rotation about the same arm axis at the end of its travel towards its releasing position, the movement of the arm being determined by guide members.

The invention relates to a device for clamping a part to a tool, of the type comprising an arm actuated by an actuator, which retracts by pivoting and which moves linearly in the tightening phase.

### PRIOR ART

Clamping devices are well known in mechanical construction.

In the oldest and most rudimentary embodiment thereof, these devices use jack screws operating in the same manner as a vice; however, said devices have the drawback, which is prohibitive today, of requiring a very long actuation time.

In more recent clamping devices, which use hydraulic or pneumatic actuators, the arm is firstly displaced by pivoting such that it is brought above the part to be clamped, and then is applied to said part by movement in translation along the pivot axis. The advantage is that the movement is fast, the part can be easily released and the translational movement prevents the displacement or stressing of the part during clamping.

Document DE 91-04053 UI shows one example of this type of clamping device.

Given the relatively high distance between the guiding and bearing thereof on the part to be clamped, the arm itself can undergo bending, which results in an unacceptable clamping inaccuracy and a limited bearing force.

### DESCRIPTION OF THE INVENTION

The purpose of the invention is to provide a highly accurate clamping device with a high clamping capacity.

For these purposes, the invention relates to a device for clamping a part to a tool, comprising an arm and actuating means, themselves comprising a body that is fastened when in use to the tool, the arm being mounted such that it can move on the body and being selectively driven by the actuating means, said arm working to travel over a determined path between a clamping position and a releasing position, and undergoing a pure movement in translation along an arm axis at the end of its travel towards its clamping position and a rotation about the same arm axis at the end of its travel towards its releasing position, the movement of the arm being determined by guide members, the clamping device being characterised in that it further comprises first bearing elements comprising a first bearing element that is fixed with respect to the body and a first movable bearing element connected to the arm, these first fixed and movable bearing elements selectively cooperating, at least at the end of the travel of the arm towards its clamping position, so as to provide each other, away from the guide members, with a sliding contact parallel to the movement in translation of the arm, and second bearing elements comprising a second bearing element that is fixed with respect to the body and a second movable bearing element connected to the arm, these second fixed and movable bearing elements cooperating so as to provide each other with a sliding contact parallel to the movement in translation of the arm, the bearing elements allowing the arm to abut against the part to be clamped.

Thanks to the first bearing elements, the arm is secured to the body when in the clamping position, which provides significant rigidity thanks to which the end thereof is protected from any risk of causing the part to be clamped to move. Moreover, on a similar scale, the transmissible force is increased compared to the prior art without first bearing elements.

The movable bearing element is, for example, constituted from a bearing heel supported by the arm and extending symmetrically on either side of a median plane of the arm and of the rod, and the first fixed bearing element is constituted from a bearing surface of the body of the actuator, on which rests the bearing heel symmetrically relative to said median plane.

According to one specific arrangement, the arm comprises a nose extending on either side of the median plane in a direction that is substantially perpendicular to the arm axis.

According to one constructive arrangement, the actuating means comprise an actuator comprising the body and a rod that is capable of moving in relation to the body along an actuator axis, the rod driving the movement of the arm.

In one specific manner, the rod and the arm have the same axis and are secured to each other. The manufacturing method of the device is simplified. Moreover, this increases the rigidity of the arm. The rotational movement of the arm also drives that of the rod, which does not pose any problem.

According to one arrangement, the guide members comprise a bore, the axis of which is the axis of the rod and wherein the rod is mounted such that it slides and pivots.

According to one improvement, the guide members comprise a removable plate supporting a guide groove, and a guide member mounted on the arm and cooperating with the guide groove. Different plate models can therefore be provided, whereby use is made of the model suited to the specific use of the device, by determining the trajectory of the arm. Therefore, the length of the translational movement can vary, and the speed and amplitude of the rotational movement can vary and can take place in one direction or the other.

According to one constructive arrangement, the guide members comprise a longitudinal groove in the extension of the guide groove. The clamping phase with a rectilinear displacement systematically takes place in all versions and the longitudinal groove, supported by the body, thus limits the size of the plate.

According to one improvement, the arm comprises two spaces for fastening the guide member. The guide member can take on two different positions, which increases the modular nature of the device, by allowing the use of the entire modulation range made possible by the plate. This arrangement is particularly useful for allowing the direction of rotation of the arm to be reversed, while preserving the entire amplitude of movement actuated over the width of the plate.

According to one constructive arrangement, the guide groove comprises a helical portion for driving the arm in rotation. The rotational movement remains combined with a translational movement of the arm and of the actuator rod.

### BRIEF DESCRIPTION OF THE FIGURES

The invention will be better understood, and other features and advantages will become apparent on reading the following description, provided with reference to the accompanying figures, in which:

FIGS. 1 and 2 are perspective views of a clamping device according to one embodiment of the invention, in the releasing position and in the clamping position respectively;

FIGS. 3 and 4 are cross-sectional views of the clamping device in FIG. 1, in the releasing position and in the clamping position respectively;

FIG. 5 is a cross-sectional view along the V-V line of the illustration in FIG. 3, without the arm;

FIG. 6 is a perspective and exploded view of the device in FIG. 1.

### DETAILED DESCRIPTION

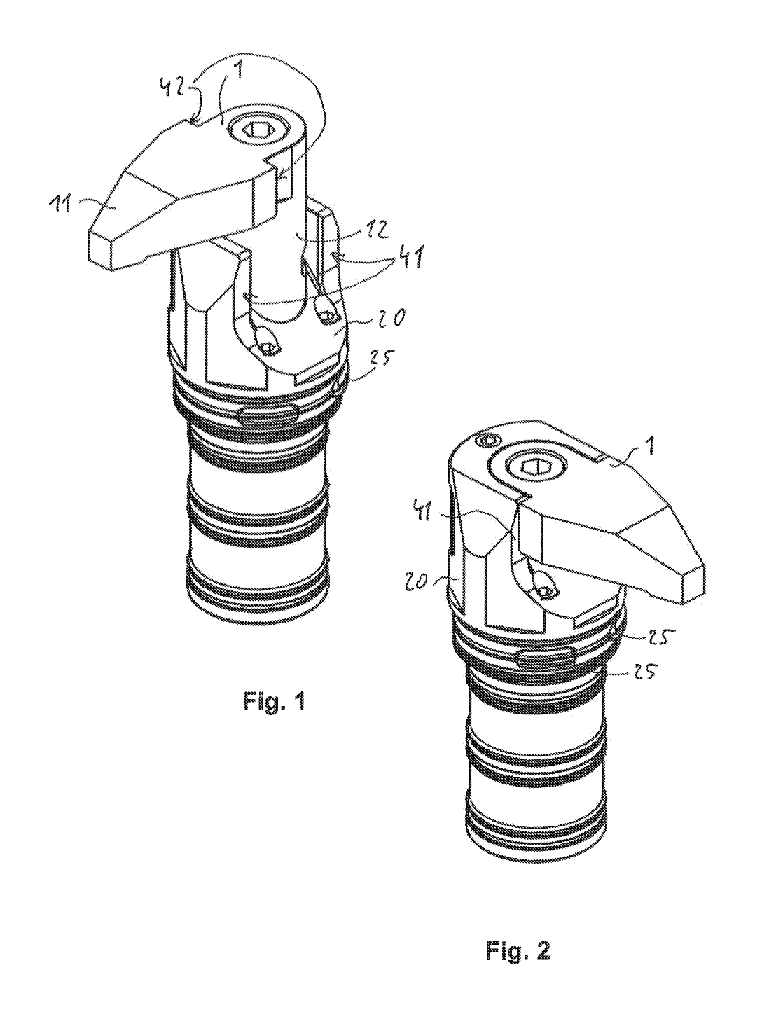

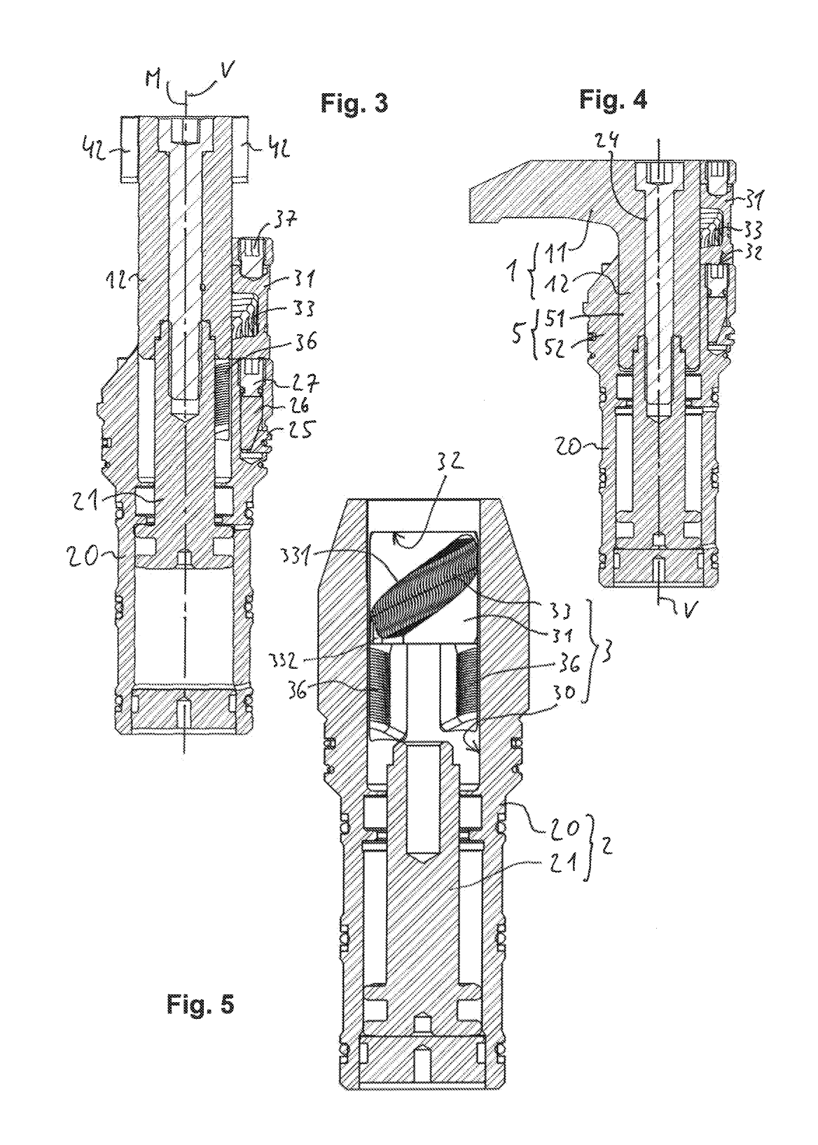

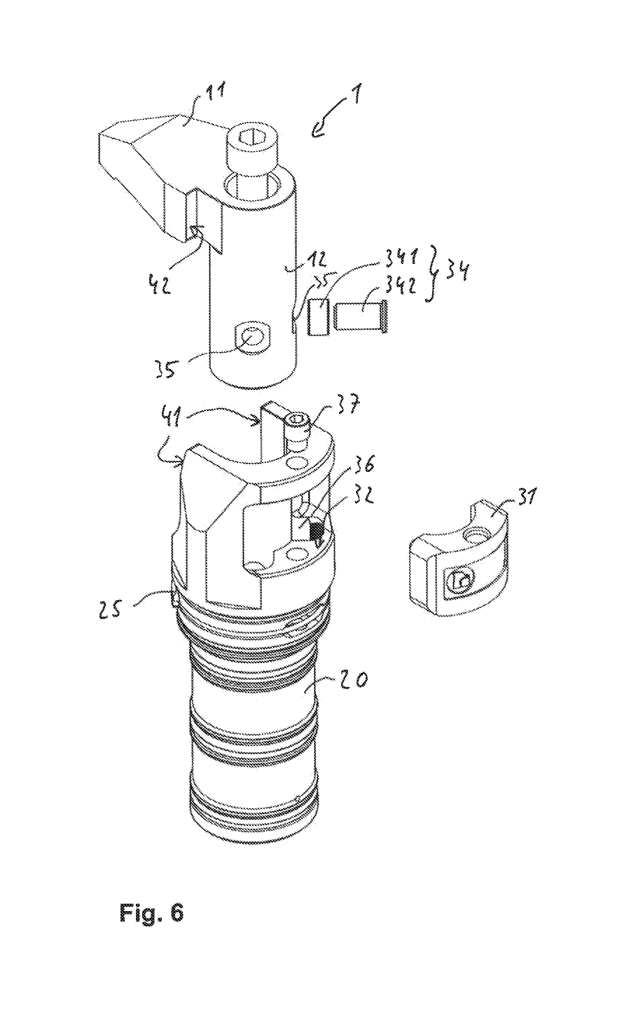

A device for clamping a part to a tool, according to one embodiment of the invention, is shown in FIG. 1 to 6. The clamping device comprises an arm 1 and actuating means 2, themselves comprising a body 20 that is fastened to the tool, not shown. The body 20 has a cylindrical outer shape and is intended to be inserted into a hollow cylindrical housing of the tool. The actuating means 2 comprise an actuator comprising the body 20 and a rod 21 that is capable of moving relative to the body 20 along an actuator axis V. The arm 1 has an overall L-shape extending in a median plane M with a nose 11 oriented substantially perpendicular relative to a trunk 12 that is cylindrical in shape, the axis of which lies in the median plane M. As shown in particular in FIGS. 3 and 4, the arm 1 is fastened to the end of the rod 21 by a screw 24 passing through the trunk 12. The rod 21 and the arm 1 therefore have the same axis V and are secured to each other.

The arm 1 is mounted such that it can move on the body 20, the trunk 12 thereof being guided in translation and rotation along the arm axis in a cylindrical bore 30 of the body 20. The arm 1 works to move over a determined path between a clamping position, such as that shown in FIGS. 2 and 4, and a releasing position, such as that shown in FIGS. 1 and 3.

The clamping device comprises guide members 3 which comprise the bore 30, which guides the rod 21 by sliding and pivoting, and a removable plate 31. The plate 31 is positioned opposite the nose 11 when the arm 1 is in the clamping position and takes a position in an opening 32 of the body 20 which provides access to the trunk 12 of the arm 1. The guide members further comprise a guide groove 33 facing the arm 1 and supported by the plate 31, and a guide member 34 mounted on the arm 1 and cooperating with the guide groove 33. In this instance, the guide member is a roller 34 comprising a ring 341 mounted such that it pivots about a pivot 342 screwed into a fastening space 35 of the arm 1, i.e. a tapped hole made in a radial direction to the trunk 12.

The guide groove 33 comprises a helical portion 331 for driving the arm 1 in rotation over the end of travel towards the releasing position, and a rectilinear portion 332 in a direction that is parallel to the axis of the arm 1 to guide the arm 1 in a pure movement of translation at the end of its travel towards its clamping position. The rectilinear portion 332 is extended by a longitudinal groove 36 inside the housing. The plate 31 is held by a teat screw 37 inserted in a longitudinal direction.

The clamping device further comprises first bearing elements 4 comprising a first bearing element 41 that is fixed with respect to the body 20 and a first movable bearing element 42 connected to the arm 1, these first fixed and movable bearing elements 4 selectively cooperating, at least at the end of travel of the arm 1 towards its clamping position, so as to provide each other, away from the guide members 3, with a sliding contact parallel to the movement in translation of the arm 1. The first movable bearing element is constituted from a bearing heel 42 supported by the arm 1 and extending symmetrically on either side of a median plane M of the arm 1 and of the rod 21, and the first fixed bearing element is constituted from a bearing surface 41 of the body 20 of the actuator, on which rests the bearing heel 42 symmetrically relative to said median plane M. The arm 1, more specifically the trunk 12, and the bore 30 respectively constitute a second movable 51 and fixed 52 bearing element. The first bearing elements 4 and the second bearing elements 5 allow the arm 1 to abut against the part to be clamped.

During operation, the device is mounted in the hollow housing of the tool, which has inlets for a pressurised fluid in order to control the actuator. 0-rings positioned at the periphery of the body 20 define annular spaces in which the fluid circulates towards an actuating chamber or other of the actuator. Fastening is provided by three blocks 25 that slide radially in the body 20 and that are controlled by wedges 26 pushed by set screws 27.

By considering an initial position to be the releasing position, the rod 21 of the actuator is protruding to a maximum degree, and the guide roller 34 is positioned in the helical portion 331 of the guide groove 33 at the end opposite the rectilinear portion 332.

When instructed to pass to the clamping position, the actuator drives the rod 21 and thus the arm 1. The guide roller 34 rolling in the helical portion 331 of the groove causes the arm 1 and the rod 21 to pivot at the same time as they move in translation. When the guide roller 34 enters the rectilinear portion 332, then the longitudinal groove 36, the arm 1 and the rod 21 undergo a pure movement in translation. The bearing heel 42 of the arm 1 thus slides along the bearing surface 41 of the body 20. The nose 11 thus comes to bear against a part, not shown, such that the arm 1 is immobilised in the clamping position with the bearing heel 42 in abutment against the bearing surface 41.

The passage to the releasing position can then be actuated by reversing the movement of the rod 21, the arm 1 thus moving in the opposite direction.

According to another feature of the invention, the plate 31 can be interchanged and the guide member 34 can change places towards a second fastening space 35. This plate 31 can have a groove that is symmetrical to that of the aforementioned embodiment relative to an axial plane, such that the releasing position is symmetrical to the aforementioned releasing position, without any changes to the clamping position.

The invention is not limited to the disclosed embodiment which is provided by way of example only. The connection between the rod and the arm could take place with a possible relative pivoting movement. The actuator could be positioned in a different location, with means for transmitting the translational movement to the arm. The guide roller could be replaced by a single pin.

The invention is not limited to the disclosed embodiment which is provided by way of example. The body, instead of being cylindrical, could comprise a base plate to be fastened to a surface of the tool.

1.-11. (canceled)

12. A clamping device for clamping a part to a tool comprising:
an arm and an actuator;
a body that, when in use, is fastened to the tool, wherein the arm is mounted so it can move on the body and is selectively driven by the actuator, the arm working to travel over a determined path between a clamping position and a releasing position, and undergoing a pure movement in translation along an arm axis at an end of its travel towards its clamping position and a rotation about the arm axis at an end of its travel towards its releasing position, the movement of the arm being determined by guide members;
a first fixed bearing element fixed with respect to the body and a first movable bearing element connected to the arm, wherein the first fixed bearing element and first movable bearing element selectively cooperates, at least at the end of the travel of the arm towards its clamping position, to provide each other, away from the guide members, with a sliding contact parallel to the movement in translation of the arm; and
a second fixed bearing element fixed with respect to the body and a second movable bearing element connected to the arm, wherein the second fixed bearing element and second movable bearing element cooperate to provide each other with a sliding contact parallel to the movement in translation of the arm,
wherein the first fixed bearing element, the first movable bearing element, the second fixed bearing element, and the second movable bearing element cooperate to allow the arm to abut against the part to be clamped.

13. The clamping device according to claim 12, wherein the first movable bearing element includes a bearing heel supported by the arm and extending symmetrically on either side of a median plane of the arm and of the actuator, and wherein the first fixed bearing element includes a bearing surface of the body of the actuator, on which rests the bearing heel symmetrically relative to the median plane.

14. The clamping device according to claim 12, wherein the arm comprises a nose extending on either side of the median plane in a direction substantially perpendicular to the arm axis.

15. The clamping device according to claim 12, wherein the actuator includes a body and a rod capable of moving in relation to the body along the arm axis, the rod driving movement of the arm.

16. The clamping device according to claim 15, wherein the rod and the arm have the same axis and are secured to each other.

17. The clamping device according to claim 15, wherein the second fixed bearing element is a bore having an axis of which is the axis of the rod; and wherein the second movable bearing element is the arm mounted so it slides.

18. The clamping device according to claim 17, wherein the second movable bearing element forms a part of the guide members, wherein the rod is mounted so it pivots.

19. The clamping device according to claim 18, wherein the guide members comprise a removable plate supporting a guide groove, and a guide member mounted on the arm and cooperating with the guide groove.

20. The clamping device according to claim 19, wherein the guide members comprise a longitudinal groove in an extension of the guide groove.

21. The clamping device according to claim 19, wherein the arm includes two fastening spaces for fastening the guide member.

22. The clamping device according to claim 19, wherein the guide groove includes a helical portion for driving the arm in rotation.
